(19) United States
(12) Patent Application Publication
(10) Pub. No.: US 2006/0124290 A1
(43) Pub. Date: Jun. 15, 2006

(54) Air conditioning method

(76) Inventors: Peter Nonnenmacher, Gaertringen (DE); Rolf Roehm, Ahornstrasse (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/537,271

(22) PCT Filed: Nov. 28, 2003
(86) PCT No.: PCT/EP03/13445

§ 371 Date: Nov. 22, 2005

(30) Foreign Application Priority Data
Dec. 2, 2002 (DE) 102 56 408.6

(51) Int. Cl. B60H 3/00; F25D 17/04; B60H 1/00; B61D 27/00

(52) U.S. Cl. 165/202; 62/186; 165/42

(57) ABSTRACT

The present invention discloses an air conditioning method in which a distinction is made between air conditioning according to a conventional method and modified air conditioning. The modified air conditioning according to the invention is used when a passenger desires further cooling, for example in the case of very high outside temperatures, and therefore adjusts the desired interior temperature further downward when cooling is already taking place at the physical limit, that is the minimum blowing-in temperature, before the evaporator ices up. As further cooling is no longer possible by reducing the blowing-in temperature, in this case, in order to obtain a noticeable further cooling effect for the passenger, the fan output is increased according to the desired inside temperature change in conjunction with the outside temperature in order to guide a larger quantity of air into the interior in the corresponding air conditioning zone and to achieve a further cooling effect by virtue of this larger mass flow.

The invention relates to an air conditioning method according to the preamble of claim 1.

A method is known from DE 43 31 142 C2, with which the interior temperature is always regulated to the set desired interior temperature by corresponding adjustment of the temperature of the medium flowing in taking account of the temperature at the time of the exterior, from which, in the case of a vehicle air conditioning system for example, the interior medium is drawn. To this end, the medium is, if appropriate, cooled and/or heated before flowing in. p The problem nevertheless exists in conventional vehicle air conditioning systems that the blowing-in temperature cannot for physical reasons, namely the icing limit of the evaporator, be colder than 1° C. to 3° C.

It is therefore not possible, especially in the case of very high outside temperatures, when a passenger would like to have it cooler than the interior temperature resulting from this minimum blowing-in temperature, for example a desired value of 20° C. instead of a desired value of 22° C., to reduce the blowing-out temperature further, and there is no response to manual air conditioning by the passenger, that is the manual reduction of the desired interior temperature.

It is therefore an object of the present invention to develop an air conditioning method in such a way that it is possible to respond to manual reduction of the desired interior temperature by at least one passenger with a perceptible regulation measure even if the minimum blowing-in temperature dependent on the icing limit of the evaporator has already been reached.

According to the invention, this object is achieved by a method with the features of claim 1. Advantageous developments of the invention are indicated in the subclaims.

By virtue of the regulation according to the invention, it is possible for a noticeable response to a manual operation, that is a reduction of the desired interior temperature, to take place even though the physical cold limit for the blowing-in temperature has already been reached.

In particular, the method according to the invention can also or rather above all be used in multi-zone air conditioning systems because in these more comfort can then be achieved for the individual seating positions as a separate adaptation of the minimum desired interior temperature is possible for each area.

These and other objects, features and advantages of the present invention become clear from the description below of a preferred illustrative embodiment in conjunction with the drawing, in which

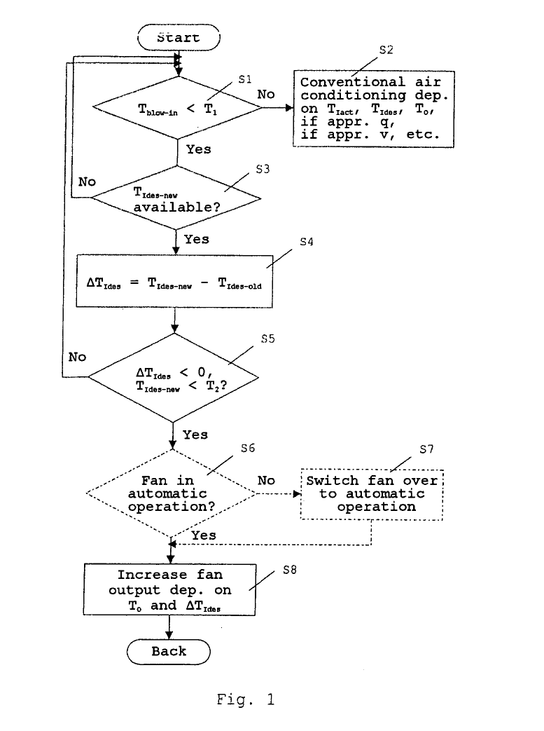

FIG. 1 shows a flow chart of the air conditioning method according to the invention.

In conventional air conditioning devices and methods, the problem exists that the blowing-in temperature T_{blow-in} cannot be colder than 1° C. to 3° C. owing to the physical limit before the evaporator ices up. On account of this, manual operations of a passenger, for example a reduction of the desired interior temperature T_{Ides} are not taken into account as regulation to a lower blowing-in temperature T_{blow-in} is not physically possible.

The air conditioning method according to the invention, with which such a problem can be eliminated and comtortable regulation for the passenger(s) is possible is described below with reference to FIG. 1.

In the air conditioning method according to the invention, the blowing-in temperature T_{blow-in} determined by a control device on the basis of the adjustment of the current desired interior temperature T_{Ides} is first compared with a preset first temperature threshold value T₁ (step S1) in order to decide whether conventional regulation depending on the actual interior temperature T_{Iact}, the desired interior temperature T_{Ides}, the outside temperature T_{O} and if appropriate the solar radiation q and/or the vehicle speed v at least the blowing-in temperature T_{blow-in} (step S2) or modified air conditioning, in which an air mass flow is regulated in addition, is carried out (steps S3 to S8). This first temperature threshold value T₁ is 10° C. for example. As soon as it is detected in step S1 that the blowing-in temperature T_{blow-in} determined lies below the temperature threshold value T₁, it is first determined in step S3 whether a new desired interior temperature T_{Ides-new} has been entered by at least one passenger, by manual operation of a desired interior temperature adjustment device for example. If this is not the case, the sequence returns to step S1. If a new desired interior temperature T_{Ides-new} is present in step S3, a desired inside temperature change ΔT_{Ides} is determined in step S4 from the difference between the new desired interior temperature T_{Ides-new} and the previous desired interior temperature T_{Ides-old}. It is then established in step S5 whether the desired interior temperature change ΔT_{Ides} has a value smaller than zero, that is the passenger has carried out a reduction of the desired interior temperature T_{Ides}, and whether the new desired interior temperature T_{Ides-new} lies below a second threshold value T₂. This threshold value T₂ is selected to be 22° C. for example as this interior temperature is regarded as comfortable for the passenger. If no previous desired interior temperature (T_{Ides-old}) is present, the second threshold value T₂ is then used as the previous desired interior temperature T_{Ides-old} in this case. If it is determined in step S5 that either no reduction of the desired interior temperature T_{Ides} is present, as the desired interior temperature change is greater than or equal to zero, and/or the new desired interior temperature T_{Ides} new is greater than or equal to the second threshold value T₂, the sequence returns to step S1. If both conditions apply, that is a negative desired inside temperature change ΔT_{Ides} and a new desired interior temperature T_{Ides-new} below the second threshold value T₂, the sequence advances to step S6. In step S6, it is checked whether the fan is in automatic operation as otherwise no automatic adaptation of the fan output is carried out. If it is detected in step S6 that the fan is not in automatic operation, the fan is switched over to automatic operation in step S7, and the sequence advances to step S8. If the fan is already in automatic operation in step S6, the sequence advances directly to step S8. In this connection, steps S6 and S7 are optional as it is likewise possible to carry out the method according to the invention exclusively when the user has set automatic operation in order that no manual user selections are canceled or ignored.

In step S8, the fan output is then increased depending on the outside temperature T_{O} and the desired interior temperature change ΔT_{Ides} determined in step S4. By virtue of this increase in fan output, a larger quantity of air is guided into the interior, so that it becomes noticeably cooler for the passenger(s) in the area of influence of this fan owing to the greater air mass flow.

In a preferred development of the invention, the air conditioning method according to the invention is applied in multi-zone air conditioning systems in such a way that the air conditioning described above with reference to FIG. 1 is carried out for each of the temperature preselection devices for the various zones as soon as determined blowing-out temperatures fall below a predetermined threshold value T₁. In this way, very comfortable air conditioning can be carried out separately for each individual air-conditioned vehicle area, so that cold-sensitive or draft-sensitive passengers located in another area are not affected by the air conditioning and therefore do not feel compromised in their comfort either.

In an alternative embodiment, step S6, in which it is checked whether the fan is in automatic operation mode, and also any switching of the fan over to automatic operation in step S7, can also take place directly after step S1. It is also possible to carry out the regulation according to the invention only when the automatic operation mode has already been switched on and not to provide any automatic switching of the fan over into automatic operation mode.

1-7. (canceled)

8. An air conditioning method with which an interior temperature is regulated to a set, stored desired interior temperature, set by a passenger, by determination and adjustment of a blowing-in temperature of a medium flowing in taking account of a temperature of an exterior from which the medium flowing in is drawn, the medium being first cooled and/or subsequently heated before flowing in depending on the temperature of the exterior and the set, stored desired interior temperature, comprising:
storing a desired interior temperature value in a first memory, determining a blowing-in temperature from a set, stored desired interior temperature value,
comparing the blowing-in temperature determined with a preset first threshold value,
carrying out air conditioning depending on an actual interior temperature, the set, stored desired interior temperature, the outside temperature, and optionally at least one of the solar radiation and the vehicle speed, by regulating at least one of the blowing-in temperature and the air mass flow if the blowing-in temperature determined is greater than or equal to the first threshold value,
determining a desired interior temperature change from the difference between the set, stored desired interior temperature and the desired interior temperature value stored in the first memory if the blowing-in temperature determined lies below the first threshold value,
establishing whether the set, stored desired interior temperature lies below a second threshold value,
again comparing the blowing-in temperature determined with the preset first threshold value when the desired interior temperature change has a value greater than or equal to zero and/or the set, stored desired interior temperature is greater than or equal to the second threshold value,
checking whether a fan of the air conditioning system, via which the air mass flow is regulated, is in automatic operation, in which the blowing-in temperature and, if appropriate, the air mass flow are regulated automatically only depending on the set, stored desired interior temperature, the outside temperature and optionally at least one of the solar radiation and the vehicle speed when the desired interior temperature change is smaller than zero and the set, stored desired interior temperature is smaller than the second threshold value,
switching the fan over to automatic operation when the fan is not in the automatic operation, and
increasing the fan output depending on the outside temperature and the desired interior temperature change, so that it becomes noticeably cooler in an area of influence of the fan, when the fan is in automatic operation or has been switched over to automatic operation.

9. The air conditioning method as claimed in claim 8, comprising switching the fan over to automatic operation directly after comparing the blowing-in temperature with the preset first thresh old value instead of after checking whether the fan is in automatic operation.

10. The air conditioning method as claimed in claim 8, wherein increasing the fan output depending on the outside temperature and the desired interior temperature change takes place using reference curves determined by measurement.

11. The air conditioning method as claimed in claim 9, wherein increasing the fan output depending on the outside temperature and the desired interior temperature change takes place using reference curves determined by measurement.

12. The air conditioning method as claimed in claim 8, wherein the method is carried out separately for each individually air-conditioned vehicle area in a multi-zone air conditioning system.

13. The air conditioning method as claimed in claim 9, wherein the method is carried out separately for each individually air-conditioned vehicle area in a multi-zone air conditioning system.

14. The air conditioning method as claimed in claim 10, wherein the method is carried out separately for each individually air-conditioned vehicle area in a multi-zone air conditioning system.

15. The air conditioning method as claimed in claim 11, wherein the method is carried out separately for each individually air-conditioned vehicle area in a multi-zone air conditioning system.

16. The air conditioning method as claimed in claim 8, wherein the desired interior temperature value stored in the first memory is a last stored desired interior temperature set by the passenger.

17. The air conditioning method as claimed in claim 9, wherein the desired interior temperature value of the first memory is the last stored desired interior temperature set by the passenger.

18. The air conditioning method as claimed in claim 10, wherein the desired interior temperature value of the first memory is the last stored desired interior temperature set by the passenger.

19. The air conditioning method as claimed in claim 11, wherein the desired interior temperature value of the first memory is the last stored desired interior temperature set by the passenger.

20. The air conditioning method as claimed in claim 12, wherein the desired interior temperature value of the first memory is the last stored desired interior temperature set by the passenger.

21. The air conditioning method as claimed in claim 13, wherein the desired interior temperature value of the first memory is the last stored desired interior temperature set by the passenger.

22. The air conditioning method as claimed in claim 14, wherein the desired interior temperature value of the first memory is the last stored desired interior temperature set by the passenger.

23. The air conditioning method as claimed in claim 15, wherein the desired interior temperature value of the first memory is the last stored desired interior temperature set by the passenger.
